(19) United States
(12) Patent Application Publication
(10) Pub. No.: US 2010/0263212 A1
(43) Pub. Date: Oct. 21, 2010

(54) Culinary Utensil

(75) Inventors: Ignaz SETTELE, Hong Kong (HK); Sabine Häutle, Kaufbeuren (DE)

Correspondence Address: WILLIAM J. SAPONE;COLEMAN SUDOL SAPONE P.C., 714 COLORADO AVENUE, BRIDGE PORT, CT, 06605, US

(73) Assignee: MAXPAT TRADING & MARKETING (FAR EAST) LIMITED, Kowloon (HK)

(21) Appl. No.: 12/533,029

(22) Filed: Jul. 31, 2009

(30) Foreign Application Priority Data
Jul. 31, 2008 (GB) 0813964.4

(51) Int. Cl. A47J 17/02; B26B 9/02; A47J 25/00

(52) U.S. Cl. 30/113.1; 30/355; 30/121.5

(57) ABSTRACT

There is provided a culinary utensil comprising a blade provided with a cutting edge on at least one side thereof, said cutting edge is formed of at least one set of taller teeth and one set of shorter teeth, wherein at least two adjacent taller teeth are separated by three to eight shorter teeth on the cutting edge.

### FIELD OF THE INVENTION

The present invention is concerned with a manual culinary utensil provided with a specially designed cutting blade mainly for cutting fruits and vegetables. The present invention is concerned with such culinary utensil but not limited to corn scraper, tomato slicer, egg slicer, and fruit or vegetable core remover or wedger.

### BACKGROUND OF THE INVENTION

There are a variety of culinary utensils for processing food or for cooking purposes. Processing for example fruits and vegetables before cooking often involves cutting, peeling and/or scraping. Many conventional culinary utensils are usually equipped with a sharp blade for cutting or peeling but despite the sharp blade these culinary utensils are not always satisfactory in their performance.

The present invention seeks to address this problem or at the least to provide an alternative to the public.

### SUMMARY OF THE INVENTION

According to one aspect of the present invention, there is provided a culinary utensil for cutting food comprising a blade provided with a cutting edge on at least one side thereof and a handle portion shaped for gripping manually by a user, the cutting edge is formed of at least one set of taller teeth and one set of shorter teeth, wherein at least two adjacent taller teeth are separated by three to eight shorter teeth on the cutting edge and the teeth are arranged consecutively along the cutting edge and pointing towards substantially the same direction whereby the cutting edge is adapted to slide linearly across the length of and cut into and through the food. Preferably, the taller teeth may generally be of the same height, and the shorter teeth may also generally be of the same height.

Preferably, the two taller teeth which are adjacent to each other may be separated by three to five shorter teeth on the cutting edge. The use of three to five shorter teeth for it can provide an optimal cutting interaction with the food to be cut. If there were too many shorter teeth between the two adjacent taller teeth the cutting edge would not readily slice into the food after the skin surface of the food is bitten into by the taller teeth, and if there were too few teeth between the adjacent taller teeth the cutting blade would not be able to break the skin of the food surface readily. While the use of three to five shorter teeth is optimal, the use of three to eight shorter teeth is still found to be satisfactory. Advantageously, the taller teeth along the blade may be evenly spaced so that a more predictable and reliable cutting can be achieved.

Suitably, the two adjacent taller teeth may be separated by a distance of substantially 4.0 mm to 6.0 mm. The taller teeth and the shorter teeth may be different in height by substantially 0.2 mm to 1.5 mm. In particular, the taller teeth may be substantially 1.0 mm to 1.5 mm in height, and the shorter teeth are substantially 0.5 mm to 1.0 mm in height.

The culinary utensil may take the form of a corn scraper for removing kernels from the core of an ear of corn. In this form, the handle may be generally elongate in shape, and wherein the blade may be generally elongate in profile and being perpendicular to the handle, with the teeth pointing towards the handle. The blade may be curved and configured to conform to the curvature of the cob of the corn. The culinary utensil may also comprise a curved plate adjacent the cutting blade and on which the corn can rest and slide along in use. The curved plate is shaped to conform to the curvature of the corn.

The culinary utensil may take the form of a tomato slicer. In this form, the blade may be generally planar. In particular, the culinary utensil may comprise a plurality of the blades generally arranged in parallel to each other, with the teeth pointing away from the utensil towards the food to be sliced. The culinary utensil may also be provided with a pair of handles arranged on opposite sides thereof.

The culinary utensil may take the form of a tool for removing the core from a fruit or vegetable. For example, it may be an apple core or a pineapple core remover and/or wedger. In this form, the culinary utensil may comprise one such blade but the blade is configured to be in a substantially round profile such as octagonal profile for cutting around the core, and also comprise at least one further such blade but configured to be planar. In particular, the round blade may be arranged in the center of the core remover. More particularly, the core remover may comprise a plurality of the blades configured to be planar and radiating from the round blade in the center thereof Similar to the tomato slicer, the core remover may also comprise a pair of handles arranged on opposite sides of the fruit core remover.

### BRIEF DESCRIPTION OF THE DRAWINGS

Embodiments of the culinary utensil according to the present invention will now be described, by ways of examples only, and with reference to the accompanying drawings, in which:

FIG. 1 is an embodiment of a cutting blade for use in a culinary utensil according to the present invention;

FIGS. 2a to 2b are perspective view, top view, front view and side view, respectively, of an embodiment of a culinary utensil according to the present invention;

FIGS. 3a to 3c show different side views and cross sectional views of a cutting portion of the culinary utensil as shown in FIG. 2a;

FIGS. 4a to 4d show different views of another embodiment of a culinary utensil according to the present invention; and

FIGS. 5a to 5b are different views of another embodiment of a culinary utensil according to the present invention.

### DETAILED DESCRIPTION OF PREFERRED EMBODIMENTS OF THE PRESENT INVENTION

The present invention is concerned with a handheld culinary utensil provided with a specially designed cutting blade mainly for cutting fruits and vegetables. The present invention is concerned with such culinary utensil but not limited to corn scraper, tomato slicer, egg slicer, and fruit or vegetable core remover or wedger. One characteristic of the blade is that as it cuts into the foodstuff it travels linearly across the length of the foodstuff without having to slide sideways reciprocatingly. This would minimize the foodstuff being pressed or squeezed as it is being cut and the juice in the foodstuff can be retained.

Embodiments of such a culinary utensil (or a blade thereof) according to the present invention are now described. These embodiments share a common characteristic in that they all comprise a novel cutting blade.

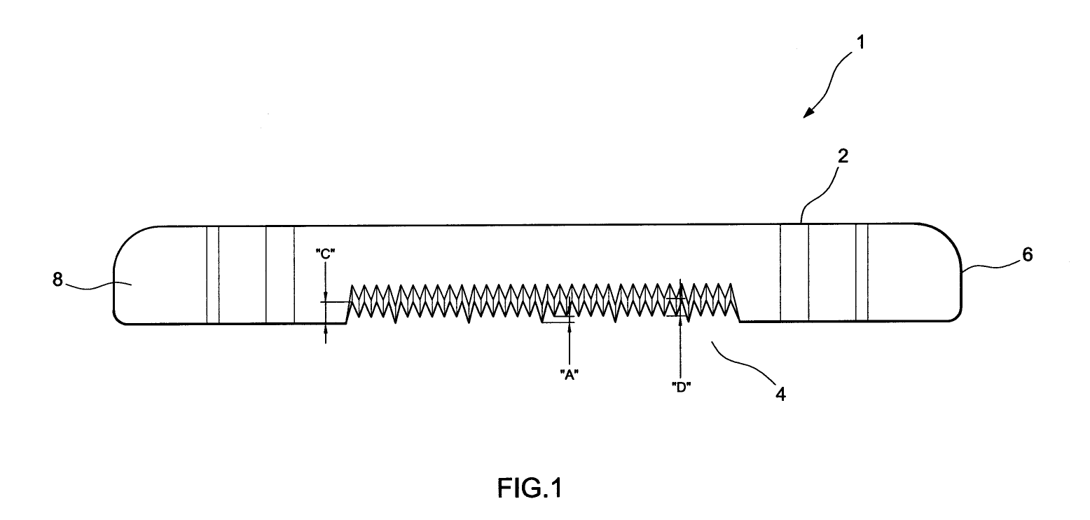

FIG. 1 shows an embodiment of a cutting blade generally designated 1 which is relatively thin and having an elongate profile. The elongate cutting blade has a relatively smooth side 2 on one of the longer sides and a cutting edge 4 on the opposite side thereof Opposite shorter sides 6, 8 of the cutting blade are regions for attachment in a culinary utensil. The cutting edge 4 has an extended length and is serrated. In particular, there is provided with a plurality of teeth members on the cutting edge. Specifically, there are a first set of teeth and a second set of teeth. The first set of teeth is taller than the second set of teeth is shorter than that in the first set. In this particular embodiment, the taller teeth are of substantially equal height and the shorter teeth are also of substantially equal height, although they do not have to be of the absolute same heights. In this embodiment, the taller teeth are taller than the shorter teeth by substantially 0.5 mm (as shown by “A”) although experiments have shown that the difference in height may be from substantially 0.2 mm to 1.5 mm and the blade will still perform satisfactorily. The teeth in this embodiment, as shown in the figures, are configured to be sharp and pointed.

One characteristic of the cutting blade 1 in this embodiment is that each adjacent taller teeth are separated by five of the shorter teeth, although experiments have demonstrated that the number of shorter teeth between each adjacent taller teeth may range from three to eight shorter teeth and the cutting blade 1 can still function satisfactorily.

The cutting blade 1 in this embodiment is designed such that the taller teeth among themselves are evenly spaced while the shorter teeth between each adjacent taller teeth are likewise evenly spaced although a slight variation of the spacing would not prejudice the cutting performance of the cutting blade 1. Specifically, in this embodiment, the adjacent taller teeth are separated by a distance of substantially 5.0 mm (as shown by “B”) although they may be separated by a distance of from substantially 4.0 mm to 6.0 mm.

Referring to the taller teeth in particular, in this embodiment, they are substantially 1.5 mm (as shown by “C”) although the height may range from substantially 1.0 to 1.5 mm or even 1.0 mm to 2.0 mm. Referring to the shorter teeth in particular, in this embodiment, they are substantially 1.0 mm (as shown by “D”) although the height may range from substantially 0.5 mm to 1.0 mm or even from substantially 0.5 mm to 1.5 mm. Regardless of the height of the taller and shorter teeth, the taller teeth will be from substantially 0.2 mm to 1.5 mm taller than the shorter teeth to perform optimally.

A first embodiment of a culinary utensil according to the present invention is one which comprises a cutting blade as described above or one which fits the description of the variations.

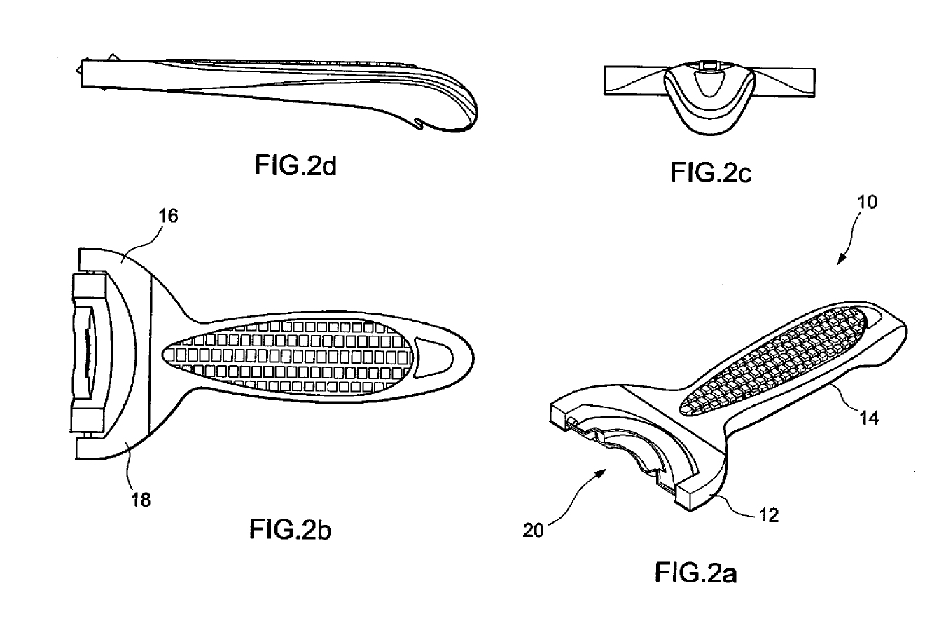

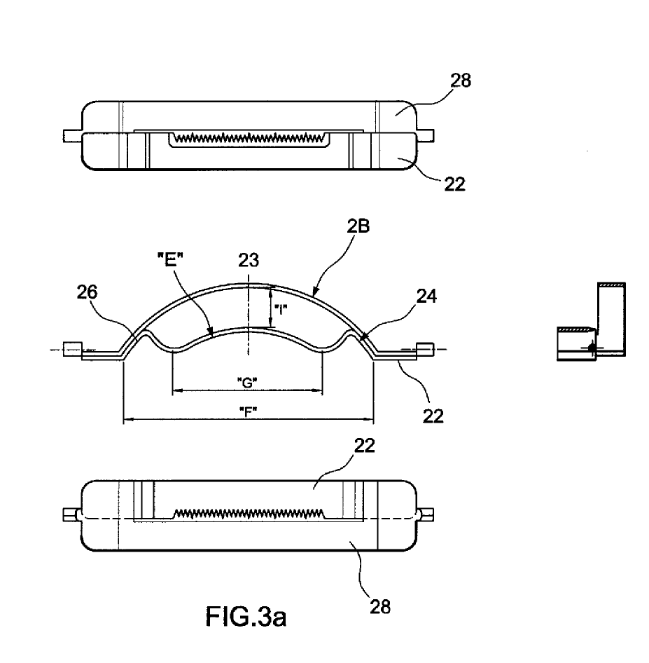

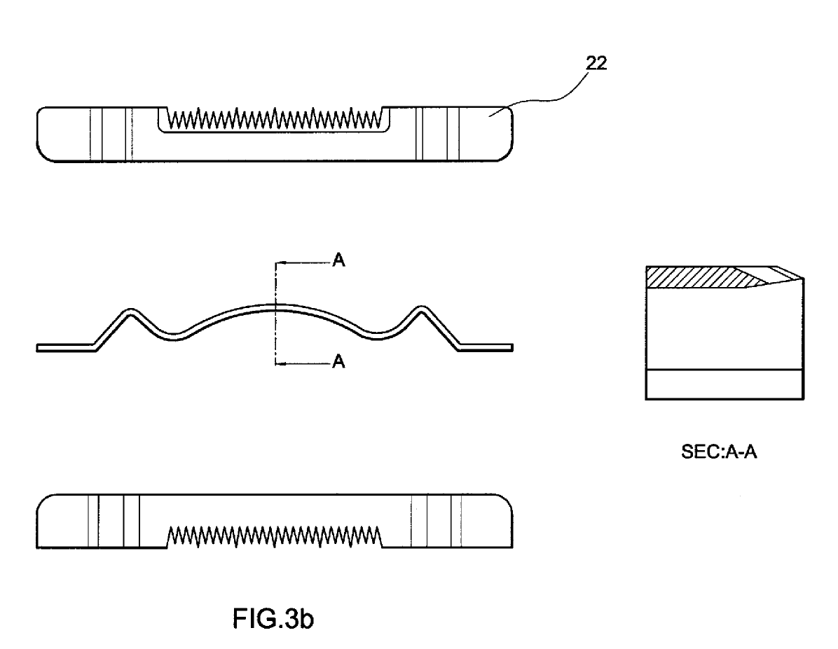

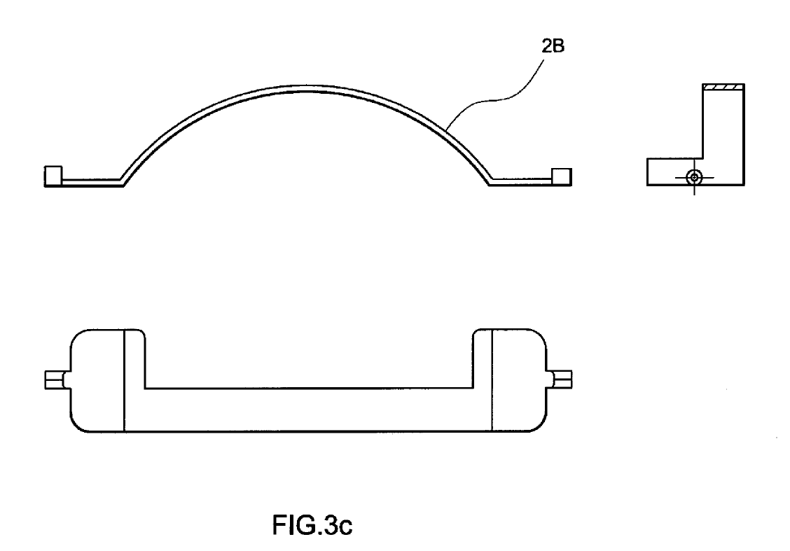

A second embodiment of a culinary utensil 10 according to the present invention takes the form of a corn scraper 10 for removing kernels from an ear of corn and is illustrated in FIGS. 2a to 3c. FIGS. 2a to 2d are artistic diagrams showing the corn scraper's appearance. The corn scraper 10 comprises a utility portion 12 and a handle portion having an elongate handle 14 defining an axis extending from the front end of the utensil to the rear end of the utensil 10. The handle 14 is sized and shaped to fit the grip of a hand of a user in use. The front end of the handle 14 forks off to two legs 16, 18 generally resembling the letter “U” and defining the utility portion 12. Between the legs there is provided with a cutting structure 20 for scraping the corn.

The cutting structure 20 includes a cutting blade 22 generally as described above and as illustrated in FIG. 1. Since this culinary utensil 10 is for scraping corn, the blade 22 is additionally configured with a curved profile, with the curvature generally fitting the curvature of the exterior surface of a corn, as shown in at least FIG. 2a, FIG. 2b and FIG. 3a. There isn't one single curvature along the entire cutting blade 22 because at different regions along the blade 22 there are different curvatures. However, in this embodiment, in the centre region of the blade the radius of curvature is substantially 20.6 mm (as shown by “E”) which generally and satisfactorily matches the curvature of most typical corns. The curved blade 22 in this embodiment has a lateral length of about 45.1 mm (as shown by “F”) although the center region only of the blade 22 has an approximate lateral length of substantially 25.4 mm (as shown by “G”), and this center region is for actually cutting into the corn and removing kernels in use. Opposite sides of the center region extend into and bent to a pair of generally inverted “V” regions 24, 26.

In the utility portion, there is provided with a plate 28 for positioning the corn in operation so that the corn can rest against the plate 28 as the blade 22 is cutting into and scraping kernels off the core. The plate 28 is likewise curved and has a curvature generally conforming to the curvature of the corn. The cutting blade 22 and the plate 28 are welded together at their lateral far ends thereof and are secured to the utility portion 12 between the legs 16, 18 pivotably. FIG. 3b shows the cutting blade 22 and FIG. 3c snows the plate 28, respectively, in isolation. As shown in for example FIG. 2a, the carved plate 28 is positioned at the front end of the utensil 10. In particular, it is located adjacent and above the cutting blade 22. There is a vertical clearance between the cured blade 28 and the cutting blade 22 at the center region thereof. Specifically, in the mid-point 23 of the center region, the clearance is about 7.0 mm, as indicated in “I”. However, studies have shown that this clearance may be from substantially 6.8 mm to 7.2 mm. Towards the opposite lateral sides of the cutting blade and the curved plates, the clearance between the curved plate 28 and the cutting blade 22 diminishes until they are connected at the regions where they are welded together.

It is envisaged that in use one end of a corn is rest on the plate 28 with the cutting edge of the cutting blade 22 facing the end of the corn. As the corn scraper 10 slides across the length of the corn the cutting edge will cut into the root region of the kernels which are then removed. One way to use the corn scraper 10 is to hold a corn with one end pointing away from the user and the opposite end pointing towards the user. Then, the corn scraper 10 can be put on top of the corn with the plate 28 resting on the far end of the corn and the cutting teeth pointing towards the handle and the user. While holding the corn still and with a pull and a relative movement of the corn scraper 10 relative to the corn, the kernels will come off conveniently. Alternatively, the corn may be held in a laterally with the corn scraper 10 sliding lateral against the corn in use. The lateral distance of the centre region of the cutting blade is about 25.4 mm and this length of cutting blade can typically remove at least three or sometimes four or more column of kernels from the corn in one sliding action.

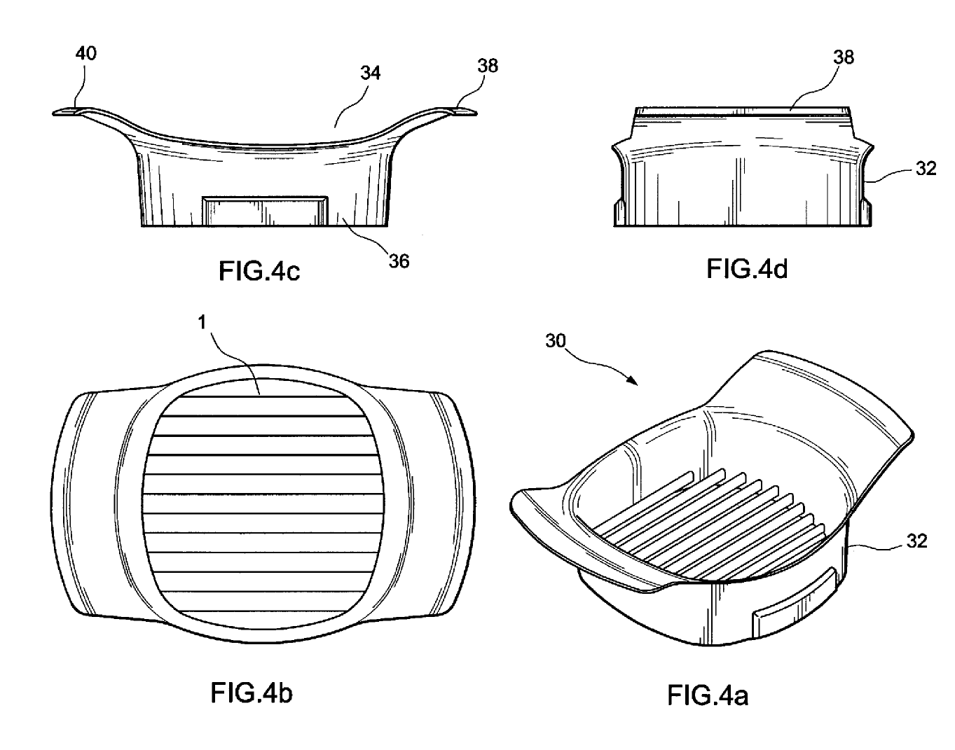

FIGS. 4a to 4d illustrate a third embodiment of a culinary utensil according to the present invention in which the culinary utensil takes the form of a food slicer 30. The food slicer 30 has a cylindrical casing 32 with an upper opening 34 and a lower opening 36. In this embodiment, the casing 32 is made of stainless steel although other suitable durable material may be used. On lateral opposite sides of the casing 32 there is a pair of handles 38, 40 extending at the top therefrom. The slicer 30 is provided with a plurality of planar cutting blades 1 as described above in FIG. 1. The cutting blades 1 are arranged in parallel and are fixedly secured within and at a lower end of the casing 32 with the cutting edge pointing downwardly. In use, when the food slicer is used, for example, to slice a tomato, a user will hold the slicer 30 on the handles 38, 40 with his hands and place the slicer 30 above the tomato. Then, the slicer 30 is lowered and pressed down onto the tomato until the cutting edge 4 is cut into and through the tomato. The slicer 30 may be used to slice an egg. Alternative embodiments of the slicer may be made by adjusting the spacing and/or number of the cutting blades 1 and the slicer will be able to produce food slicer of different thickness.

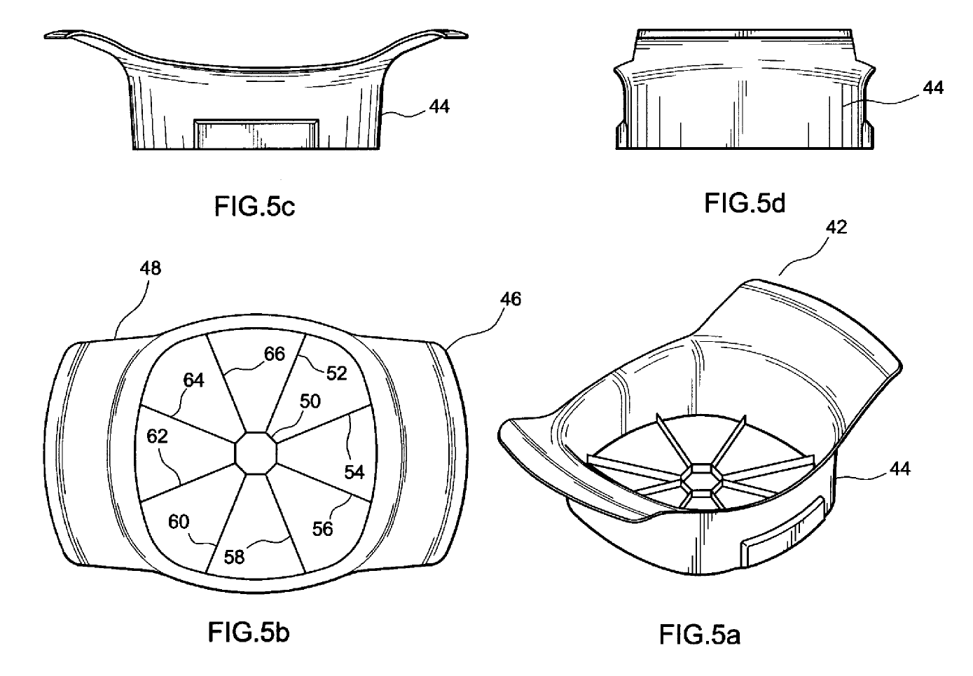

FIGS. 5a to 5d illustrate a fourth embodiment of a culinary utensil according to the present invention in which the culinary utensil takes the form of a fruit or vegetable core remover (and slicer) 42. This core remover 42 is generally similar to the slicer described in FIGS. 4a to 4d in that it similarly comprises a through-cylindrical casing 44 and a pair of handles 46, 48. One main difference is that instead of having a plurality of cutting blades arranged in parallel, there is provided one cutting blade 50 bent to an octagonal shape and this octagonal cutting blade is arranged in the center within the cylindrical casing with the cutting edge pointing downwardly. There is provided eight further planar cutting blades 52, 54, 56, 58, 60, 62, 64, 66, as described in FIG. 1. These eight blades 52, 54, 56, 58, 60, 62, 64, 66 extend radially from the center of the core remover 42 to the inner surroundings of the casing 44, connecting the casing 44 and the octagonal cutting blade 50. The cutting edge of the eight planar cutting blades 52, 54, 56, 58, 60, 62, 64, 66 similarly points away from the handles 46, 48 of the slicer. Alternative embodiments of the core remover 42 may be made by using a circular cutting blade in the center instead of an octagonal cutting blade and/or reducing or increasing the number of the radially extending planar blades 1 so that the number of resulting food slices will be different.

The cutting blade 1 as shown in FIG. 1 and the culinary utensils in FIGS. 2a to 5d comprising one or more of the cutting blades 1 sharing one common characteristic, i.e. the teeth arrangement on the cutting edge of the blade 1. Studies during the course of the invention have identified that conventional cutting blades are not satisfactory in some cutting operation particularly when slicing certain vegetables. For example, the studies have found that a straight cutting edge of a cutting blade when initially engaging with the surface of a tomato tends to press onto instead cutting into the tomato surface. Especially when the tomato is fresh and the skin is tight or has a relatively high tension, despite the cutting edge pressing onto the surface of the tomato the skin often would not break and as the cutting edge would then further press on the tomato and would smash or tend to smash the tomato before the its skin is broken or cut into. The studies have also identified that while providing a cutting edge with alternately taller and shorter teeth would not improve the cutting mechanism significantly and the slicing process is still unsatisfactory. The studies leading 1:o the invention have identified that arranging three to eight shorter teeth between every adjacent taller teeth and with the teeth are arranged consecutively along the cutting edge and pointing towards substantially the same direction such that blade adapted to slide linearly into and across the length of the foodstuff would solve the problem. Specifically, the taller teeth will be able to bite into the skin of the tomato, and vegetables in generally, effectively on first contact and then once with the skin broken the cutting with minimal back and fro movement of the utensil will follow easily. Further, since there is no or little reciprocating sideway movement of the blade, no or minimal smashing will occur and juice within the vegetables or foodstuff to be cut will be retained and not squeezed out. The studies have also identified that while the exact relative dimensions of the teeth would slightly affect the performance of the cutting action, as long as there are three to eight shorter teeth between the adjacent taller teeth the blade is able to firstly penetrate the skin effectively. With the characteristics of the blade or the culinary utensils above in accordance with the present invention, the motion of the blade in use is such that it travels essentially in a linear direction towards and into the food to be cut, sliced or scrapped, with relatively little or no sideway or reciprocating back and fro motion while cutting, slicing or scrapping into the food. This essentially linear direction improvers the cutting efficiency and reduces smashing the food or squeezing the juice out.

It should be understood that certain features of the invention, which are, for clarity, described in the context of separate embodiments, may be provided in combination in a single embodiment. Conversely, various, features of the invention, which are, for brevity, described in the context of a single embodiment, may also be provided separately or in any appropriate sub-combinations. Further, dimensions of certain features are provided as non-limiting examples only.

1. A culinary utensil for cutting food comprising a blade provided with a cutting edge on at least one side thereof and a handle portion shaped for gripping manually by a user, wherein said cutting edge is formed of at least one set of taller teeth and one set of shorter teeth, wherein at least two adjacent taller teeth are separated by three to eight shorter teeth on the cutting edge and the teeth are arranged consecutively along the cutting edge and pointing towards substantially the same direction whereby the cutting edge is adapted to slide linearly across the length of and cut into and through the food.

2. A culinary utensil as claimed in claim 1, wherein said two adjacent taller teeth are separated by three to five shorter teeth on the cutting edge.

3. A culinary utensil as claimed in claim 1, wherein said taller teeth are evenly spaced along the cutting edge.

4. A culinary utensil as claimed in claim 1, wherein said two adjacent taller teeth are separated by a distance of substantially 4.0 mm to 6.0 mm.

5. A culinary utensil as claimed in claim 1, wherein the taller teeth and the shorter teeth are different in height by substantially 0.2 mm to 1.5 mm.

6. A culinary utensil as claimed in claim 1, wherein said taller teeth are substantially 1.0 mm to 1.5 mm in height.

7. A culinary utensil as claimed in claim 1, wherein the shorter teeth are substantially 0.5 mm to 1.0 mm in height

8. A culinary utensil as claimed in claim 1, wherein the culinary utensil is a corn scraper.

9. A culinary utensil as claimed in claim 8, wherein said handle is generally elongate in shape, and wherein the blade is generally elongate in profile and being perpendicular to the handle, with the teeth pointing towards the handle.

10. A culinary utensil as claimed in claim 8, wherein the blade is curved generally conforming to the curvature of the cob of an ear of corn.

11. A culinary utensil as claimed in claim 8, further comprising a curved plate adjacent the blade and on which an ear of corn can rest and slide along in use.

12. A culinary utensil as claimed in claim 1, wherein the culinary utensil is a tomato slicer.

13. A culinary utensil as claimed in claim 12, wherein the blade is generally planar.

14. A culinary utensil as claimed in claim 12, comprising a plurality of said blades generally arranged in parallel to each other.

15. A culinary utensil as claimed in claim 12, further comprising a pair of handles arranged on opposite sides of the tomato slicer.

16. A culinary utensil as claimed in claim 1, wherein the culinary utensil is fruit or vegetable core remover.
